(19) United States
(12) Patent Application Publication
(10) Pub. No.: US 2021/0350765 A1
(43) Pub. Date: Nov. 11, 2021

(54) DISPLAY WITH LOCALIZED BRIGHTNESS ADJUSTMENT AND RELATED METHODS

(71) Applicant: CORNING INCORPORATED, CORNING, NY (US)

(72) Inventor: Xiang-Dong Mi, Pittsford, NY (US)

(21) Appl. No.: 17/150,548

(22) PCT Filed: Jul. 8, 2019
(86) PCT No.: PCT/US2019/040770

§ 371 Date: Jan. 15, 2021

(51) Int. Cl. G09G 5/10; G09G 3/3225; G09G 3/36

(52) U.S. Cl. CPC G09G 5/10; G09G 3/3225; G09G 3/3648; G09G 2320/066; G09G 2360/141; G09G 2360/144; G09G 2354/00; G09G 2320/0686

(57) ABSTRACT

A display system with local brightening function, the system including a display unit to display an image to a user; a sensor to detect an event, including an interaction with the display system by the user or an ambient lighting condition; and a control unit to determine a specified region of the display unit corresponding to a targeted area of the event. The control unit can change a spatial luminance of the display system based on the event, where the display system switches from a first operation mode to a second operation mode when the event is detected and, in the second operation mode, a luminance of the specified region relative to other regions of the display unit is different than a luminance of the specified region relative to the one or more other regions in the first operation mode.

### CROSS-REFERENCE TO RELATED APPLICATIONS

This application claims the benefit of priority under 35 U.S.C. § 119 of U.S. Provisional Application Ser. No. 62/698,330 filed on Jul. 16, 2018 the content of which is relied upon and incorporated herein by reference in its entirety.

### FIELD OF THE DISCLOSURE

The disclosure relates to a display with localized brightness control, and more particularly to a display for vehicle interior systems where a local area of the display brightens in response to an external event, and methods of performing the same.

### BACKGROUND

Displays are used in a variety of products and applications to display static icons, dynamic visuals or video, photos and images, messages, and other information. Such displays may be used in mobile devices, such as smart phones, mp3 players, and computer tablets. Displays are also used in architectural, transportation (e.g., automotive, trains, aircraft, sea craft, etc.), and appliance applications. Generally, the brightness of a display is controlled based on the ambient environment of the display device and user preferences. For example, a poorly lit environment usually requires lower brightness than a brightly lit environment. Also, a brightness level suitable for one user may not be suitable for another user. In a typical display device, a user adjusts the brightness manually. Such adjustments may be made by mechanical and/or software interfaces, such as a switch, a keypad, a dial, or a touch screen. The brightness usually remains at the fixed level until the user changes the level.

A fixed brightness level may be suitable when the ambient lighting conditions are optimized or constant during operation of the display device, or in applications where only occasional user adjustment is needed. However, in many applications, a fixed brightness level may not be suitable and may not be desirable. In mobile device applications, for example, the device is, of course, mobile and thus can be used in a variety of environments with different lighting conditions. Even in a given environment, the device itself may be moved or reoriented relative to the surroundings, which can effectively change the ambient lighting conditions of the display even when the surroundings of the device remain constant.

Displays in vehicles face concerns similar to those of mobile consumer electronics devices, as well as additional challenges. Vehicles are mobile and thus a display in a vehicle interior can be exposed to dynamic ambient lighting conditions. In addition, displays in vehicle interiors often have limited or no mobility relative to the vehicle. As a result, a viewer of the display may not be able to reorient the display to overcome harsh ambient lighting conditions. Furthermore, users of in-vehicle displays often have little time to view the display for safety reasons, making readability of the display very important. For example, a driver of a typical car or even an assisted-driving or semi-autonomous vehicle may be primarily focused on the road, and may only read or interact with a display in quick intervals so as not to be distracted from driving. Even passengers or those in fully-autonomous vehicles may wish to avoid extended viewing of a display for a variety of reasons, including avoid motion sickness.

While increased brightness can enhance readability of displays, it typically requires additional power, which can quickly drain energy systems that power the display (or that power an entire vehicle). The increased brightness can have additional side effects of generating more heat or being distracting or uncomfortable for users. For example, the number and size of displays in automotive vehicles have increased and are expected to continue to do so. If the entire display area of a surface has high brightness, that brightness can be uncomfortable for users, make it difficult to see the road, or otherwise impair the safe operating of a vehicle.

In automotive applications, one approach is to reduce the brightness of a display device when the headlights are turned on. A user may further adjust the brightness manually. There essentially are two brightness “levels”—a first level when the lights are turned off and a second, lower level or range when the lights are turned on. However, this approach does not automatically change the brightness in relation to changing ambient light conditions. Additionally, there may be unsuitable brightness levels for particular ambient light conditions.

Accordingly, there is a need for displays that have controlled brightness adjustments for improved readability and safety, including displays capable of local brightness adjustment, and methods related to performing such brightness adjustments.

### SUMMARY

In one aspect, embodiments of the disclosure relate to a display system. The display system includes a display unit, a sensor, and a control unit. The display unit displays an image to a user. The sensor can detect an event that is an interaction with the display system by the user, or an ambient lighting condition in an environment of the display system. The control unit determines a specified region of the display unit corresponding to a targeted area of the event, and changes a spatial luminance of the display system based on the event. The display system can thus switch from a first operation mode to a second operation mode when the event is detected. In the second operation mode, a luminance of the specified region relative to one or more other regions of the display unit is different than a luminance of the specified region relative to the one or more other regions in the first operation mode.

In another aspect, embodiments of a vehicle incorporating a display system are provided. The display system is disposed on or in a vehicle dashboard, a vehicle center console, a vehicle door, a vehicle instrument cluster, a vehicle climate or radio control panel, an in-vehicle display, or a vehicle passenger entertainment panel.

Another embodiment of the disclosure relates to a method of providing local brightening for a display system. The methods include the steps of providing a display module to display an image to a user, providing a light source to illuminate the image, and providing a sensor to detect an event that is an interaction with the display system by the user or and an ambient lighting condition in an environment of the display system. The method further includes detecting the event and determining a specified region of the display unit corresponding to a targeted area of the event. Additionally, the method includes switching from a first operation mode of the display system to a second operation mode of the display system in response to the event. The first operation mode includes providing a uniform spatial luminance via the light source, the uniform spatial luminance comprising a first luminance value, and the second operation mode includes providing a variable spatial luminance comprising a second luminance value in the specified region and the first luminance value in one or more other regions of the display unit, the second luminance value being greater than the first luminance value.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a vehicle interior with vehicle interior systems utilizing a display system according to one or more of the embodiments discussed herein;

FIG. 2A shows a cross-sectional schematic view of a display system according to one or more embodiments discussed herein;

FIG. 2B shows an isometric exploded view of the display system of FIG. 2A according to one or more embodiments discussed herein;

FIG. 3 is an exploded plan view of components of the display system of FIG. 2 in a first operation mode according to one or more embodiments discussed herein;

FIG. 4 is an exploded plan view of the components of FIG. 3 in a second operation mode according to one or more embodiments discussed herein; and

FIGS. 5A-5D are schematic illustrations of an example user interface displayed on a display system according to one or more embodiments discussed herein.

### DETAILED DESCRIPTION

Typical approaches to brightness control are an “all-or-nothing” approach, where the brightness for an entire display is adjusted by the same amount. Therefore, there is a need for display systems capable of localized brightness control. In particular, there is a need for display systems capable of on-demand local brightening in response to an external condition, such as an ambient lighting condition, or a user need or interaction. Accordingly, embodiments of a display system and related methods are described.

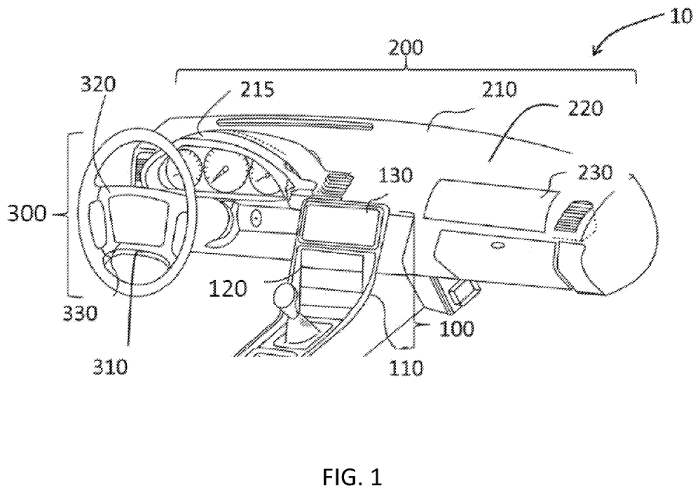

Referring to FIG. 1, vehicle interior systems may include a variety of different displays for communicating information to driver and/or passengers. FIG. 1 shows a vehicle interior 10 that includes three different vehicle interior systems 100, 200, 300, according to an embodiment. Vehicle interior system 100 includes a center console base 110 with a curved surface 120 including a display, shown as display 130, which may be a flat or curved display. Vehicle interior system 200 includes a dashboard base 210 with a curved surface 220 including a display 230, which may be a flat or curved display. The dashboard base 210 typically includes an instrument panel 215, which may also include a curved display. Vehicle interior system 300 includes a dashboard steering wheel base 310 with a surface 320 and a display, shown as a display 330, either of which may also be flat or curved. In one or more embodiments, the vehicle interior system may include a base that is an arm rest, a pillar, a seat back, a floor board, a headrest, a door panel, or any portion of the interior of a vehicle that includes a curved surface.

The embodiments of the display system described herein can be used in any or all of vehicle interior systems 100, 200 and 300. While FIG. 1 shows an automobile interior, the various embodiments of the vehicle interior system may be incorporated into any type of vehicle such as trains, automobiles (e.g., cars, trucks, buses and the like), sea craft (boats, ships, submarines, and the like), and aircraft (e.g., drones, airplanes, jets, helicopters and the like), including both human-piloted vehicles, semi-autonomous vehicles and fully autonomous vehicles. Further, while the description herein relates primarily to vehicle display applications, it should be understood that various deadfront embodiments discussed herein may be used in any type of display application.

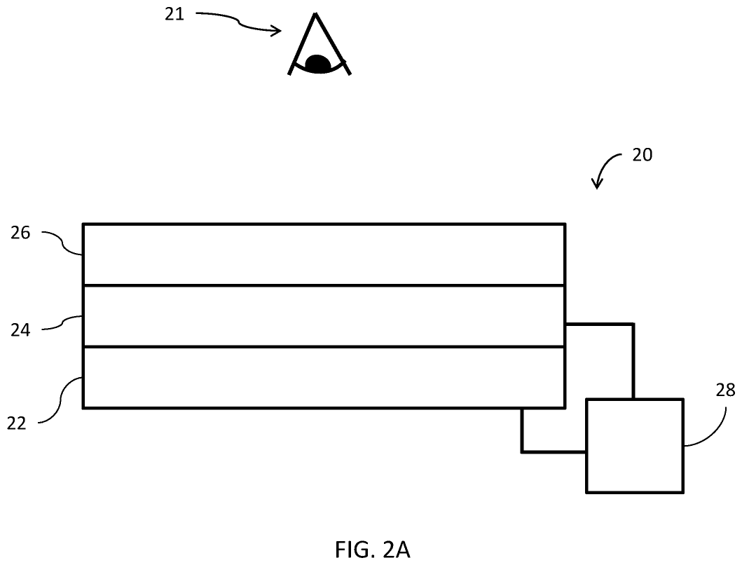

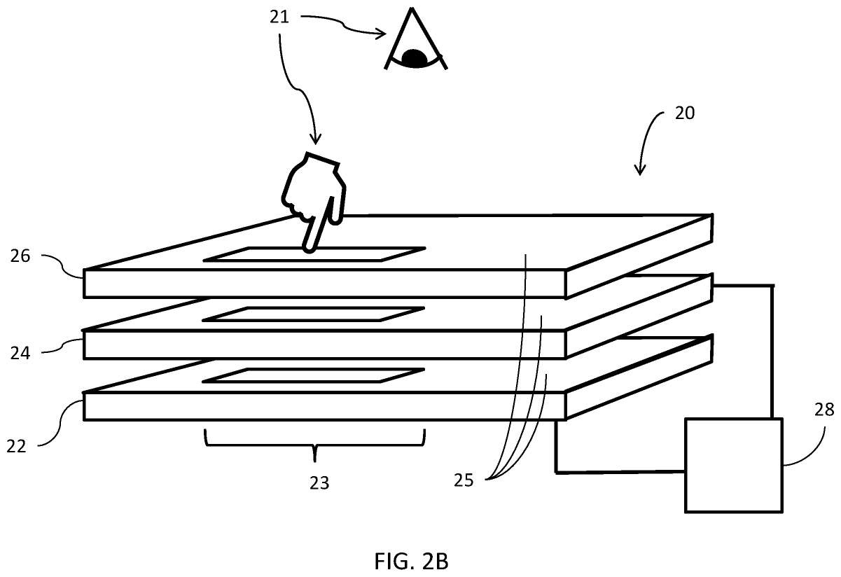

Referring to FIGS. 2A and 2B, which show an example of one or more embodiments, a display system 20 includes a display unit 24 to display an image to a user 21, sensor 26, and a control unit 28. The display system 20 may switch from a first operation mode to a second operation mode when an event is detected by the sensor 26. According to some embodiments, the change from the first to the second operation mode results in a change in brightness in a localized region of the display. The event may include, for example, an action performed by the user 21. Actions performed by a user include direct interactions with the display system 20, such as a physical touch by the user 21 on a touchscreen as shown in FIG. 2B, a gesture performed by the user on or in the vicinity of the display screen, a touch or gesture performed on or near a control apparatus of the display system, a voice-activated interaction with the display system, or an eye movement or viewing direction of the user. The event may also include an ambient lighting condition in an environment of the display system,

As used herein, a “user” refers to any one interacting with or viewing the display, including one whom is in a position to view or interact with the display, whether or not that person is actually viewing and/or interacting with the display. For example, in a vehicle, a user can be a driver or passenger of the vehicle.

In embodiments discussed herein, the backlight and display panel are connected to control circuitry, which is connected to a voltage supply. The display device may be separate or incorporated with other components, such as a dashboard in an automobile or other vehicle, a portable electronic device, and the like.

Upon the sensor 24 detecting the event, the control unit 28 may determine a specified region 23 of the display unit 24 that is relevant to the event and may change a spatial luminance of the display system 20 based on the event. The specified region 23 may correspond to a targeted area of the event. For example, a targeted area of an event may include an area of the display touched by the user 21, as shown in FIG. 2B, or an area indicated by the user using some other control apparatus, including physical controls or a graphical user interface. In some embodiments, the event, such as a user interaction, may not be targeted to any particular area of a display, but the control unit may determine the specified region based on an area that is determined to be suitable or appropriate for displaying information or increasing brightness in response to the interaction. For example, a voice command from a user may result in the control unit determining a location for the specified region to be a location that the viewer may comfortably or safely view, such as a dashboard display or head-up display (HUD) for a driver, or a rear passenger display for a rear passenger. In some embodiments, the specified region may be determined based on a configuration of the vehicle, including a fixed location of a particular display or graphic, or a location of a relevant user control.

The first and second operation modes can operate in a variety of ways, according to various embodiments. In some embodiments, a luminance of the specified region 23 relative to one or more other regions 25 of the display unit is different in the second operation mode than a luminance of the specified region relative to the one or more other regions in the first operation mode. As an aspect of some embodiments, a contrast ratio of the specified region 23 may increase relative to other regions 25 of the display 24 so that a viewer can more easily or more quickly comprehend the information communicated by the display system 20. In another aspect of some embodiments, the display may be in an “off” state in the specified region 23 and/or the other regions 25 in the first operation mode, and only the specified region 23 is in an “on” state in the second operation mode or both the specified region 23 and one or more of the other regions 25 are in an on state in the second operation mode.

In some embodiments, the display system 20 includes a light source 22 that produces light to illuminate an image of the display unit 24 so that it can be viewed by the user 21. The light source 22 can be a backlight unit, a laser projection system, one or more light-emitting diodes, or other source of light used for displays that would be contemplated by a person of ordinary skill in the art of displays. In the first operation mode, the light source 22 may produce a uniform spatial luminance, whereas, in the second operation mode, the light source 22 produces a variable spatial luminance. As used herein, “spatial luminance” refers to a distribution of luminance values in space of the display 24 and/or light source 22. The spatial distribution may be one-dimensional or two-dimension. It is contemplated that the spatial luminance may also be three-dimensional for a three-dimensional display, such as a hologram. A “uniform spatial luminance” refers to a spatial luminance in which the luminance values fall within a certain range over the spatial distribution. In some embodiments, a uniform spatial luminance may include luminance values in a range from 70% to 100% of a maximum luminance value of the distribution. A “variable spatial luminance” refers to a spatial luminance in which the luminance values are not uniform across the spatial distribution. For example, a variable spatial luminance may include luminance values that fall outside of the range specified for a uniform spatial luminance, such as the example range described above of about 70% to 100%. As an aspect of some embodiments, “luminance” is the amount of light emitted from a user-facing surface of the light source, display unit, or cover glass between the display unit and user, as measured per unit area in the direction of the user. In some embodiments, the luminance refers to only a surface area of the display through which light is transmitted to the user.

In one or more embodiments, the variable spatial luminance includes one or more areas of the display system corresponding to the targeted area exhibiting a first luminance, and one or more areas that do not correspond to the targeted area exhibiting a second luminance. The first luminance is different than the second luminance and, in particular embodiments, the first luminance is greater than the second luminance. However, in some embodiments, the first luminance may be less than the second luminance. The variable spatial luminance may also be designed to increase an ambient contrast ratio of the specified region of the display unit, which may make the information in the targeted area easier to read for a user, particular in difficult reading conditions such as direct sunlight incident on the display, for example.

The specified region of the display is intended to occupy less than 100% of a surface area of the display unit. Thus, the brightness control is “local” or “localized” in that only the specified area of the display exhibits the change in luminance in the second operation mode. The variable spatial luminance can be a variable luminance in one-dimension or in two-dimensions. Accordingly, a sensor (e.g., such as a touch panel 26 in FIG. 2B) may be used to detect an event (e.g., a touch by user 21) in one-dimension or in-two dimensions. Thus, the control unit can control the spatial luminance in one-dimension or in two-dimensions based on the spatial detection by the sensor. This dimensional detection and control allows for the localized brightness control of various embodiments of this disclosure.

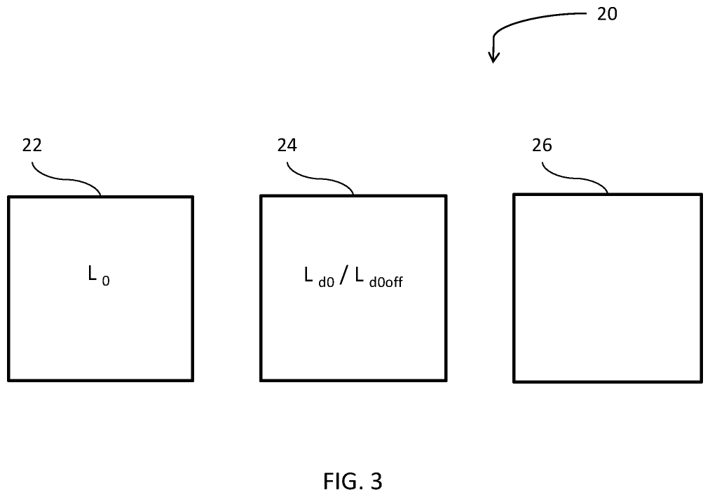

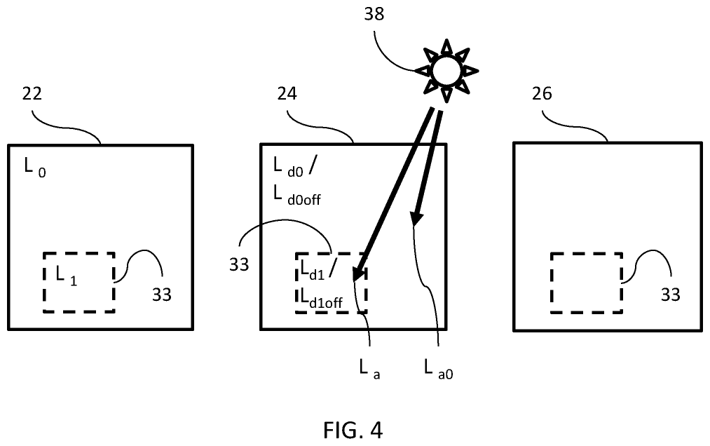

The luminance values of various components and states of the display system will now be discussed with reference to FIGS. 3 and 4 to illustrate the structure and operation of some embodiments. In FIG. 3, the display system 20 is in an on state and in the first operation mode, where the uniform spatial luminance can be expressed as having a luminance value L₀ for the light source 22 and a luminance value L_{d0} for the display unit 24 in a direction toward the user. When the display system 20 is in an off state, the display unit 24 has a luminance value L_{d0off} in a direction toward the user. As discussed herein, a light source 22 such as a backlight unit may not have a perfectly uniform luminance, and thus may have a range of luminance values from about 70% to 100% of the maximum luminance Lₘₐₓ (not shown) of the light source 22. In the second operation mode, shown in FIG. 4, the variable spatial luminance can be expressed as having a luminance value L₁ for the light source 22 in the specified region 33, a luminance value L₀ for the light source 22 in other regions of the light source outside of the specified region 33, a luminance value L_{d1} for the display unit 24 in the specified region 33 when the display is on and L_{d1off} when the display is off, as measured in a direction toward the user.

The presence of ambient light 38 will affect luminance values of a display in that a portion of the ambient light incident on the display 24 can be reflected toward the user. An amount of ambient light directed to the user from the specified region 33 can be expressed as Lₐ, and an amount of ambient light directed to the user from a region other than the specified region can be expressed is Lₐ₀, as shown in FIG. 4. In some embodiments, a ratio Lₐ₀/Lₐ may less than 10, for example.

A contrast ratio CRₐ of the display system in the specified region in the first operation mode satisfies the following Equation 1:

$${CR}_{a} = \frac{{L}_{d 0} + {L}_{a}}{{L}_{d 0 off} + {L}_{a}} . \qquad Equation 1$$

A contrast ratio CRₐ₀ of the display system in the one or more other regions satisfies the following Equation 2:

$$C {R}_{a 0} = \frac{{L}_{d 0} + {L}_{a 0}}{{L}_{d 0 off} + {L}_{a 0}} . \qquad Equation 2$$

When in the second operation mode, the specified region exhibits a luminance value L₁ for the light source and a luminance value L_{d1} for the display unit in the on state and L_{d1off} in the off state, where L₁ is greater than L₀. In the second operation mode, the one or more other regions can exhibit the luminance value L₀. Thus, a contrast ratio CRₐ of the display system in the specified region in the second operation mode satisfies the following Equation 3:

$${CR}_{a} = \frac{{L}_{d 1} + {L}_{a}}{{L}_{d 1 off} + {L}_{a}} . \qquad Equation 3$$

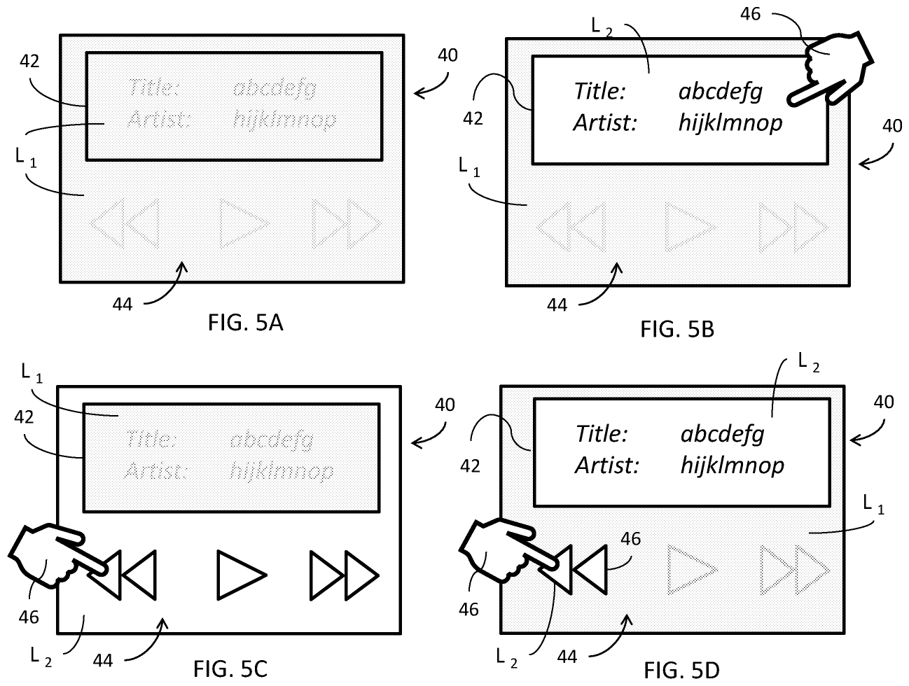

FIGS. 5A-5D show examples of a display system 40, according to some embodiments. The display system 40 is displaying a graphical user interface (GUI) in the form of a media player interface that includes an information window 42 and a control section 44. The media player interface is used as an example, but embodiments discussed herein are not limited to this particular example. In FIGS. 5A-5D, the display system 40 is active or in an “on” state, but the display is shown in various operation states. The state of the display system 40 in FIG. 5A correspond to a first operation mode of the display system where the information window 42 and control section 44 exhibit a luminance value L₁ in the direction of the user. For example, the luminance value L₁ may correspond to the luminance of the display when the user has not performed an action to cause a local brightness adjustment. For example, the display may be in a “sleep” or “stand-by” mode, where the brightness of the display is reduced to converse energy or for some other reason, or the display may simply be exhibiting its default brightness. Alternatively, the luminance value L₁ may be the result of ambient light incident on the display system reducing the effective brightness or contrast of the display system as viewed by the user. In FIG. 5B, the display system 50 is in a second operation mode in response to detection of a user's touch 46 in the information window 42. Specifically, the display system 40 detects the touch 46 and determines that an effective area for brightness adjustment based on the targeted area of the touch 46 being the information window 42. Thus, the control unit of the display system 40 activates the second operation mode, as shown. In this second operation mode, the information window 42 is adjusted to have a luminance value L₂, which is a higher than luminance value L₁, while the other regions to the display system (i.e., the control section 44) remains at a luminance value of L₁.

In further examples, shown in FIGS. 5C and 5D, the user's touch 46 occurs in the region of the control section 44. Accordingly, the control unit of the display system 40 determines an effective area for brightness adjust based on the user's touch 46. In FIG. 5C, the control unit determines that the effective is the entire control section 44 and a surrounding area, but not the information section 42. Therefore, the control section 44 and a surrounding area have a luminance value L₂ and the information section 42 retains a luminance value of L₁. In FIG. 5D, the control unit of the display system 40 determines that the effective area is a specific control 46 of the control section 44 that is touched 46 by the user. In other words, only the specific control 46 that is touched receives a local brightness adjustment, while other areas of the control section 44 retain the luminance value L₁. In addition, the control unit can determine that the information section 42 is also part of the specified area and perform a brightness adjustment for the information section 42, as well. Thus, the information section 42 in FIG. 5D also has a luminance value L₂.

As is clear from the foregoing, a number of light sources can be used in various embodiments. Depending on the light source, the brightness capabilities of the display will vary. For example, in some embodiments, the light source can have a first brightness level in a range from about 500 nits to about 1500 nits in the first operation mode. In addition, the light source can have a second brightness level in a range from about 1000 nits to about 3000 nits at the specified region in the second operation mode, where the second brightness level is greater than the first brightness level.

Examples of the display unit include an OLED display, LCD display, LED display, or a DLP MEMS chip. However, it is contemplated that embodiments of this disclosure can include any display type which a person of ordinary skill in the art would consider appropriate.

In some embodiments, the sensor can include a single sensor or multiple sensors. When using multiple sensors, the sensors can include multiples of the same type of sensor or a variety of types of sensors that work individually or in concert. In some embodiments, the sensor may be a touch panel, a proximity sensor, a light sensor, an ultrasonic sensor, an optical image sensor, an eye-tracking system, or a microphone. The sensors may be incorporated into the display unit itself, or behind a substrate or cover glass intermediate the display and user. However, the sensor may be located elsewhere and be in communication with the control unit of the display system. Examples of suitable touch panels include any of a variety of suitable touch panels, such as a resistive touch panel, a capacitive (e.g., surface or projected) touch panel, a surface acoustic wave touch panel, an infrared touch panel, an optical imaging touch panel, dispersive signal touch panel, or an acoustic pulse recognition touch panel. In embodiments, the touch panel is laminated to the display or a cover glass intermediate the display and a user using an optically clear adhesive. In other embodiments, the touch panel is printed onto the cover glass such that the optically clear adhesive is unnecessary. Advantageously, the touch panel is cold bendable to provide a three-dimensional shape.

When the sensor is used to detect an interaction by the user, the interaction may be one or more of the following: a touch of the display system or control unit by the user, which is detected by the touch panel, the light sensor, the optical image sensor, or the ultrasonic sensor; a proximity of the user to the proximity sensor, the optical image sensor, or the ultrasonic sensor; a gesture by the user detected by the touch panel, the light sensor, the ultrasonic sensor, or the optical image sensor; a viewing direction of one or both eyes of the user detected by the eye tracking system; and a voice activation by the user detected by the microphone. In some embodiments, the sensor includes a touch panel that can detect a duration or force magnitude of the touch by the user, and the control unit can adjust the luminance of the specified region by a variable degree based on the duration or force of the touch.

When the sensor is used to detect an ambient lighting condition, the ambient lighting condition detected can be, for example, an amount of ambient light incident on the targeted area, or a difference in brightness of ambient light incident on the targeted area relative to ambient light incident on another region of the display unit. For example, the control unit may determine that the event has occurred when the amount of ambient light detected by the sensor exceeds some predetermined amount, or when the difference between the amount of ambient light incident on the targeted area and the amount of ambient light incident on the other area exceeds some predetermined amount.

The display systems and methods of this disclosure are suitable for a number of display applications. However, particular embodiments include the display system being disposed on or in a vehicle dashboard, a vehicle center console, a vehicle door, a vehicle instrument cluster, a vehicle climate or radio control panel, an in-vehicle display, or a vehicle passenger entertainment panel.

One or more embodiments further include a method for providing local brightening for a display system. The method may include providing a display module that can display an image to a user of the display system; providing a light source to illuminate that image; and providing a sensor to detect an event. The light source is capable of a spatial luminance that is variable in one dimension or two dimensions. The event can include an interaction by the user with the display system or with a vehicle having the display system. The even can also include an ambient lighting condition in an environment of the display system. The method further includes detecting the event, determining a specified region of the display based on the event, and switching from a first operation mode of the display system to a second operation mode of the display system in response to the event. In the first operation mode, a uniform spatial luminance is provided by the light source, where the uniform spatial luminance exhibits a first luminance value. In the second operation mode, a variable spatial luminance is providing by the light source and exhibits a second luminance value in the specified region and the first luminance value in one or more other regions of the display unit. According to some embodiments, the second luminance value is greater than the first luminance value. The specified region of the display may be determined based on a determination that the event relates to or targeted that region of the display, for example.

The sensor can include a touch panel, a proximity sensor, a light sensor, an ultrasonic sensor, an optical image sensor, an eye-tracking system, or a microphone. Correspondingly, the interaction by the user may include at least one of: a touch by the user detected by at least one of the touch panel, the light sensor, the optical image sensor, and the ultrasonic sensor; a proximity of the user to the proximity sensor, the optical image sensor, or the ultrasonic sensor; a gesture by the user detected by at least one of the touch panel, the light sensor, the ultrasonic sensor, and the optical image sensor; a viewing direction of one or both eyes of the user detected by the eye tracking system; or a voice activation by the user detected by the microphone.

In some embodiments, an ambient lighting condition is detected by the sensor. The ambient lighting condition can be, for example, an amount of ambient light incident on the targeted area that exceeds a threshold amount, or a difference in brightness of ambient light incident on the targeted area relative to ambient light incident on the one or more other regions of the display unit. In addition, the method can include detecting a duration of the event (e.g., duration of a user's touch) and a magnitude of the second luminance value is based on the duration of the event.

As used herein, a “display” is any component that communicates information to a user or viewer of the display via light transmitted to the user from the display, where the light can be transmitted by, through, or off of (i.e., reflected by) the display. Displays may use an external or dedicated light source or may be emissive. Displays using a dedicated light source that is separate from the display portion may be back-lit, front-lit, or edge-lit, where the light source is positioned to provide light for a display panel. Emissive display devices have pixels that are the emissive light source. In emissive displays, the pixel light source may be a CRT phosphor, a FED phosphor, a light emitting diode (LED) or micro-LED, an organic LED (OLED), an electroluminescent, or any emissive display technology. In backlight display devices, the backlight may be a fluorescent tube, an electro-luminescent device, a gaseous discharge lamp, a plasma panel, LED, and the like. The display panel may, for example, be a light emitting diode (LED) and may be a passive or active matrix liquid crystal display (LCD).

Displays may also include one or more static or dynamic icons or images formed by the light source itself, or a combination of a light source and one or more static image formed on a substrate intermediate the light source and a viewer of the display. The substrate may include one or more layers that include plastic or polymer, glass, glass-ceramic, and/or ceramic materials. The images may be formed on or in the substrate by a coating on a surface of the substrate, a cut-out in the substrate, or other structural or compositional changes in the substrate itself.

In some embodiments, the display system also includes a glass substrate or cover glass intermediate the display unit and the user. The glass substrate may be characterized as having a first surface arranged to face the user, a second surface opposite the first surface, and a minor surface between the first and second major surfaces and defining a thickness of the glass substrate. The glass substrate is at least partially transparent to the light produced by the light source, so that the light may be transmitted through the substrate to the user for viewing information from the display. For example, the glass substrate may be at least partially transparent to light in a range from about 400 nm to about 700 nm. For the substrate, “transparent” means that sufficient visible light may pass therethrough and be perceived by the user so that the information from the display can be comprehended. For example, the substrate, including any layers or coatings such as decorative ink or deadfront coatings, may have an average light transmittance in a range of from about 5% to about 30%, at least 35%, at least 40%, at least 45%, at least 50%, at least 55%, at least 60%, at least 65%, at least 70%, at least 75%, at least 80%, at least 85%, at least 90%, at least 95%, or about 100% along the entire wavelength range from about 400 nm to about 700 nm. As used herein, the term “transmittance” is defined as the percentage of incident optical power within a given wavelength range transmitted through a material.

The glass substrate has an average thickness between the first surface and the second surface. In one or more embodiments, outer glass substrate has a thickness (t) that is in a range from 0.05 mm to 2 mm. In various embodiments, outer glass substrate has a thickness (t) that is about 1.5 mm or less. For example, the thickness may be in a range from about 0.1 mm to about 1.5 mm, from about 0.15 mm to about 1.5 mm, from about 0.2 mm to about 1.5 mm, from about 0.25 mm to about 1.5 mm, from about 0.3 mm to about 1.5 mm, from about 0.35 mm to about 1.5 mm, from about 0.4 mm to about 1.5 mm, from about 0.45 mm to about 1.5 mm, from about 0.5 mm to about 1.5 mm, from about 0.55 mm to about 1.5 mm, from about 0.6 mm to about 1.5 mm, from about 0.65 mm to about 1.5 mm, from about 0.7 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, or from about 0.3 mm to about 0.7 mm.

In some embodiments, the display and/or the glass substrate may be curved. For example, the substrate can include one or more curved portions on the first major surface. A curved portion has a first radius of curvature, which can be, for example, in a range from 20 mm to about 10000 mm or from about 60 mm to about 1500 mm, and may further include a second curved portion with a second radius of curvature having substantially the same or a different magnitude and direction from the first radius of curvature. For example the first and/or second radius of curvature may be in a range from about 20 mm to about 10,000 mm, from about 30 mm to about 10,000 mm, from about 40 mm to about 10,000 mm, from about 50 mm to about 10,000 mm, 60 mm to about 10,000 mm, from about 70 mm to about 10,000 mm, from about 80 mm to about 10,000 mm, from about 90 mm to about 10,000 mm, from about 100 mm to about 10,000 mm, from about 120 mm to about 10,000 mm, from about 140 mm to about 10,000 mm, from about 150 mm to about 10,000 mm, from about 160 mm to about 10,000 mm, from about 180 mm to about 10,000 mm, from about 200 mm to about 10,000 mm, from about 220 mm to about 10,000 mm, from about 240 mm to about 10,000 mm, from about 250 mm to about 10,000 mm, from about 260 mm to about 10,000 mm, from about 270 mm to about 10,000 mm, from about 280 mm to about 10,000 mm, from about 290 mm to about 10,000 mm, from about 300 mm to about 10,000 mm, from about 350 mm to about 10,000 mm, from about 400 mm to about 10,000 mm, from about 450 mm to about 10,000 mm, from about 500 mm to about 10,000 mm, from about 550 mm to about 10,000 mm, from about 600 mm to about 10,000 mm, from about 650 mm to about 10,000 mm, from about 700 mm to about 10,000 mm, from about 750 mm to about 10,000 mm, from about 800 mm to about 10,000 mm, from about 900 mm to about 10,000 mm, from about 950 mm to about 10,000 mm, from about 1,000 mm to about 10,000 mm, from about 1250 mm to about 10,000 mm, from about 1500 mm to about 10,000 mm, from about 1750 mm to about 10,000 mm, from about 2000 mm to about 10,000 mm, from about 2500 mm to about 10,000 mm, from about 3000 mm to about 10,000 mm, from about 4000 mm to about 10,000 mm, from about 5000 mm to about 10,000 mm, from about 6000 mm to about 10,000 mm, from about 7000 mm to about 10,000 mm, from about 8000 mm to about 10,000 mm, from about 20 mm to about 9000 mm, from about 20 mm to about 8000 mm, from about 20 mm to about 7000 mm, from about 20 mm to about 6000 mm, from about 20 mm to about 5000 mm, from about 20 mm to about 4000 mm, from about 20 mm to about 3000 mm, from about 20 mm to about 2500 mm, from about 20 mm to about 2000 mm, from about 20 mm to about 1950 mm, from about 20 mm to about 1900 mm, from about 20 mm to about 1850 mm, from about 20 mm to about 1800 mm, from about 20 mm to about 1750 mm, from about 20 mm to about 1700 mm, from about 20 mm to about 1650 mm, from about 20 mm to about 1600 mm, from about 20 mm to about 1550 mm, from about 20 mm to about 1500 mm, from about 20 mm to about 1450 mm, from about 20 mm to about 1400 mm, from about 20 mm to about 1300 mm, from about 20 mm to about 1200 mm, from about 20 mm to about 1100 mm, from about 20 mm to about 1000 mm, from about 20 mm to about 950 mm, from about 20 mm to about 900 mm, from about 20 mm to about 850 mm, from about 20 mm to about 800 mm, from about 20 mm to about 750 mm, from about 20 mm to about 700 mm, from about 20 mm to about 650 mm, from about 20 mm to about 200 mm, from about 20 mm to about 550 mm, from about 20 mm to about 500 mm, from about 20 mm to about 450 mm, from about 20 mm to about 400 mm, from about 20 mm to about 350 mm, from about 20 mm to about 300 mm, from about 20 mm to about 250 mm, from about 20 mm to about 200 mm, from about 20 mm to about 150 mm, from about 20 mm to about 100 mm, from about 20 mm to about 50 mm, from about 60 mm to about 1400 mm, from about 60 mm to about 1300 mm, from about 60 mm to about 1200 mm, from about 60 mm to about 1100 mm, from about 60 mm to about 1000 mm, from about 60 mm to about 950 mm, from about 60 mm to about 900 mm, from about 60 mm to about 850 mm, from about 60 mm to about 800 mm, from about 60 mm to about 750 mm, from about 60 mm to about 700 mm, from about 60 mm to about 650 mm, from about 60 mm to about 600 mm, from about 60 mm to about 550 mm, from about 60 mm to about 500 mm, from about 60 mm to about 450 mm, from about 60 mm to about 400 mm, from about 60 mm to about 350 mm, from about 60 mm to about 300 mm, or from about 60 mm to about 250 mm. In one or more embodiments, glass substrate having a thickness of less than about 0.4 mm may exhibit a radius of curvature that is less than about 100 mm, or less than about 60 mm.

As a further aspect of some embodiments, the glass substrate is curved, either alone or following attachment to an underlying display and/or backlight, via a cold-forming process. As used herein, the terms “cold-bent,” “cold-bending,” “cold-formed” or “cold-forming” refers to curving the glass substrate at a cold-form temperature which is less than the softening point of the glass (as described herein). A feature of a cold-formed glass substrate is an asymmetric surface compressive between the first major surface and the second major surface. In some embodiments, prior to the cold-forming process or being cold-formed, the respective compressive stresses in the first major surface and the second major surface are substantially equal. In one or more embodiments, the compressive stress on the first major surface (i.e., the concave surface following bending) after cold-forming increases.

Without being bound by theory, the cold-forming process increases the compressive stress of the glass substrate being shaped to compensate for tensile stresses imparted during bending and/or forming operations. In one or more embodiments, the cold-forming process causes the first major surface to experience compressive stresses, while the second major surface (e.g., the convex surface following bending) experiences tensile stresses.

In various embodiments, the glass substrate may have a compound curve including a major radius and a cross curvature. A complexly curved cold-formed glass substrate may have a distinct radius of curvature in two independent directions. According to one or more embodiments, the complexly curved cold-formed glass substrate may thus be characterized as having “cross curvature,” where the cold-formed glass substrate is curved along an axis (i.e., a first axis) that is parallel to a given dimension and also curved along an axis (i.e., a second axis) that is perpendicular to the same dimension. The curvature of the cold-formed glass substrate can be even more complex when a significant minimum radius is combined with a significant cross curvature, and/or depth of bend.

According to some embodiments, displays described herein may have a “deadfront” appearance. In general, a deadfront appearance blocks visibility of underlying display components, icons, graphics, etc. when the display is off, but allows display components to be easily viewed when the display is on or activated (in the case of a touch-enabled display. In addition, an article that provides a deadfront effect (i.e., a deadfront article) can be used to match the color or pattern of the article to adjacent components to eliminate the visibility of transitions from the deadfront article to the surrounding components.

Suitable glass compositions for the glass substrate include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %, from about 67 mol % to about 80 mol %, from about 68 mol % to about 80 mol %, from about 69 mol % to about 80 mol %, from about 70 mol % to about 80 mol %, from about 72 mol % to about 80 mol %, from about 65 mol % to about 78 mol %, from about 65 mol % to about 76 mol %, from about 65 mol % to about 75 mol %, from about 65 mol % to about 74 mol %, from about 65 mol % to about 72 mol %, or from about 65 mol % to about 70 mol %, and all ranges and sub-ranges therebetween.

In one or more embodiments, the glass composition includes Al₂O₃ in an amount greater than about 4 mol %, or greater than about 5 mol %. In one or more embodiments, the glass composition includes Al₂O₃ in a range from greater than about 7 mol % to about 15 mol %, from greater than about 7 mol % to about 14 mol %, from about 7 mol % to about 13 mol %, from about 4 mol % to about 12 mol %, from about 7 mol % to about 11 mol %, from about 8 mol % to about 15 mol %, from 9 mol % to about 15 mol %, from about 9 mol % to about 15 mol %, from about 10 mol % to about 15 mol %, from about 11 mol % to about 15 mol %, or from about 12 mol % to about 15 mol %, and all ranges and sub-ranges therebetween. In one or more embodiments, the upper limit of Al₂O₃ may be about 14 mol %, 14.2 mol %, 14.4 mol %, 14.6 mol %, or 14.8 mol %.

In one or more embodiments, glass layer(s) herein are described as an aluminosilicate glass article or including an aluminosilicate glass composition. In such embodiments, the glass composition or article formed therefrom includes SiO₂ and Al₂O₃ and is not a soda lime silicate glass. In this regard, the glass composition or article formed therefrom includes Al₂O₃ in an amount of about 2 mol % or greater, 2.25 mol % or greater, 2.5 mol % or greater, about 2.75 mol % or greater, about 3 mol % or greater.

In one or more embodiments, the glass composition comprises B₂O₃ (e.g., about 0.01 mol % or greater). In one or more embodiments, the glass composition comprises B₂O₃ in an amount in a range from about 0 mol % to about 5 mol %, from about 0 mol % to about 4 mol %, from about 0 mol % to about 3 mol %, from about 0 mol % to about 2 mol %, from about 0 mol % to about 1 mol %, from about 0 mol % to about 0.5 mol %, from about 0.1 mol % to about 5 mol %, from about 0.1 mol % to about 4 mol %, from about 0.1 mol % to about 3 mol %, from about 0.1 mol % to about 2 mol %, from about 0.1 mol % to about 1 mol %, from about 0.1 mol % to about 0.5 mol %, and all ranges and sub-ranges therebetween. In one or more embodiments, the glass composition is substantially free of B₂O₃.

As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ (e.g., about 0.01 mol % or greater). In one or more embodiments, the glass composition comprises a non-zero amount of P₂O₅ up to and including 2 mol %, 1.5 mol %, 1 mol %, or 0.5 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is greater than or equal to about 8 mol %, greater than or equal to about 10 mol %, or greater than or equal to about 12 mol %. In some embodiments, the glass composition includes a total amount of R₂O in a range from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 13 mol %, and all ranges and sub-ranges therebetween. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount greater than or equal to about 8 mol %, greater than or equal to about 10 mol %, or greater than or equal to about 12 mol %. In one or more embodiments, the composition includes Na₂O in a range from about from about 8 mol % to about 20 mol %, from about 8 mol % to about 18 mol %, from about 8 mol % to about 16 mol %, from about 8 mol % to about 14 mol %, from about 8 mol % to about 12 mol %, from about 9 mol % to about 20 mol %, from about 10 mol % to about 20 mol %, from about 11 mol % to about 20 mol %, from about 12 mol % to about 20 mol %, from about 13 mol % to about 20 mol %, from about 10 mol % to about 14 mol %, or from 11 mol % to about 16 mol %, and all ranges and sub-ranges therebetween.

In one or more embodiments, the glass composition includes less than about 4 mol % K₂O, less than about 3 mol % K₂O, or less than about 1 mol % K₂O. In some instances, the glass composition may include K₂O in an amount in a range from about 0 mol % to about 4 mol %, from about 0 mol % to about 3.5 mol %, from about 0 mol % to about 3 mol %, from about 0 mol % to about 2.5 mol %, from about 0 mol % to about 2 mol %, from about 0 mol % to about 1.5 mol %, from about 0 mol % to about 1 mol %, from about 0 mol % to about 0.5 mol %, from about 0 mol % to about 0.2 mol %, from about 0 mol % to about 0.1 mol %, from about 0.5 mol % to about 4 mol %, from about 0.5 mol % to about 3.5 mol %, from about 0.5 mol % to about 3 mol %, from about 0.5 mol % to about 2.5 mol %, from about 0.5 mol % to about 2 mol %, from about 0.5 mol % to about 1.5 mol %, or from about 0.5 mol % to about 1 mol %, and all ranges and sub-ranges therebetween. In one or more embodiments, the glass composition may be substantially free of K₂O.

In one or more embodiments, the glass composition is substantially free of Li₂O. In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In some embodiments, the glass composition includes a non-zero amount of RO up to about 2 mol %. In one or more embodiments, the glass composition comprises RO in an amount from about 0 mol % to about 1.8 mol %, from about 0 mol % to about 1.6 mol %, from about 0 mol % to about 1.5 mol %, from about 0 mol % to about 1.4 mol %, from about 0 mol % to about 1.2 mol %, from about 0 mol % to about 1 mol %, from about 0 mol % to about 0.8 mol %, from about 0 mol % to about 0.5 mol %, and all ranges and sub-ranges therebetween.

In one or more embodiments, the glass composition includes CaO in an amount less than about 1 mol %, less than about 0.8 mol %, or less than about 0.5 mol %. In one or more embodiments, the glass composition is substantially free of CaO.

In some embodiments, the glass composition comprises MgO in an amount from about 0 mol % to about 7 mol %, from about 0 mol % to about 6 mol %, from about 0 mol % to about 5 mol %, from about 0 mol % to about 4 mol %, from about 0.1 mol % to about 7 mol %, from about 0.1 mol % to about 6 mol %, from about 0.1 mol % to about 5 mol %, from about 0.1 mol % to about 4 mol %, from about 1 mol % to about 7 mol %, from about 2 mol % to about 6 mol %, or from about 3 mol % to about 6 mol %, and all ranges and sub-ranges therebetween.

In one or more embodiments, the glass composition comprises ZrO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises ZrO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition comprises SnO₂ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises SnO₂ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to (and including) about 1 mol %. In some embodiments, the glass composition is substantially free of Fe. In one or more embodiments, the glass composition comprises Fe₂O₃ in an amount equal to or less than about 0.2 mol %, less than about 0.18 mol %, less than about 0.16 mol %, less than about 0.15 mol %, less than about 0.14 mol %, less than about 0.12 mol %. In one or more embodiments, the glass composition comprises Fe₂O₃ in a range from about 0.01 mol % to about 0.2 mol %, from about 0.01 mol % to about 0.18 mol %, from about 0.01 mol % to about 0.16 mol %, from about 0.01 mol % to about 0.15 mol %, from about 0.01 mol % to about 0.14 mol %, from about 0.01 mol % to about 0.12 mol %, or from about 0.01 mol % to about 0.10 mol %, and all ranges and sub-ranges therebetween.

Where the glass composition includes TiO₂, TiO₂ may be present in an amount of about 5 mol % or less, about 2.5 mol % or less, about 2 mol % or less or about 1 mol % or less. In one or more embodiments, the glass composition may be substantially free of TiO₂.

An exemplary glass composition includes SiO₂ in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein.

### Strengthened Substrate

In one or more embodiments, the substrate includes a glass material (such as outer glass substrate 2010 or other glass substrate) of any of the display system embodiments discussed herein. In one or more embodiments, such glass substrates may be strengthened. In one or more embodiments, the glass substrate may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In one or more embodiments, the glass substrates used in the deadfront articles discussed herein may be strengthened mechanically by utilizing a mismatch of the coefficient of thermal expansion between portions of the glass to create a compressive stress region and a central region exhibiting a tensile stress. In some embodiments, the glass substrate may be strengthened thermally by heating the glass to a temperature above the glass transition point and then rapidly quenching.

In one or more embodiments, the glass substrate used in the display systems discussed herein may be chemically strengthening by ion exchange. In the ion exchange process, ions at or near the surface of the glass substrate are replaced by—or exchanged with—larger ions having the same valence or oxidation state. In those embodiments in which the glass substrate comprises an alkali aluminosilicate glass or soda lime silicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass substrate generate a stress.

Ion exchange processes are typically carried out by immersing a glass substrate in a molten salt bath (or two or more molten salt baths) containing the larger ions to be exchanged with the smaller ions in the glass substrate. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the glass substrate in a salt bath (or baths), use of multiple salt baths, additional steps such as annealing, washing, and the like, are generally determined by the composition of the glass substrate (including the structure of the substrate and any crystalline phases present) and the desired DOC and CS of the substrate that results from strengthening.

Exemplary molten bath composition may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on the glass thickness, bath temperature and glass (or monovalent ion) diffusivity. However, temperatures and immersion times different from those described above may also be used.

In one or more embodiments, the glass substrate used in the display systems may be immersed in a molten salt bath of 100% NaNO₃, 100% KNO₃, or a combination of NaNO₃ and KNO₃ having a temperature from about 370° C. to about 480° C. In some embodiments, the glass substrate of a deadfront article may be immersed in a molten mixed salt bath including from about 5% to about 90% KNO₃ and from about 10% to about 95% NaNO₃. In one or more embodiments, the glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass substrate used to form the display system cover glass may be immersed in a molten, mixed salt bath including NaNO₃ and KNO₃ (e.g., 49%51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass substrate of a deadfront article. The spike may result in a greater surface CS value. This spike can be achieved by single bath or multiple baths, with the bath(s) having a single composition or mixed composition, due to the unique properties of the glass compositions used in the glass substrate of a deadfront article described herein.

In one or more embodiments, where more than one monovalent ion is exchanged into the glass substrate used in the deadfront articles, the different monovalent ions may exchange to different depths within the glass substrate (and generate different magnitudes stresses within the glass substrate at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four-point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass substrate. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from Glasstress Ltd., located in Tallinn Estonia), depending on the strengthening method and conditions. When the glass substrate is chemically strengthened by an ion exchange treatment, FSM or SCALP may be used depending on which ion is exchanged into the glass substrate. Where the stress in the glass substrate is generated by exchanging potassium ions into the glass substrate, FSM is used to measure DOC. Where the stress is generated by exchanging sodium ions into the glass substrate, SCALP is used to measure DOC. Where the stress in the glass substrate is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrate is measured by FSM. Central tension or CT is the maximum tensile stress and is measured by SCALP.

In one or more embodiments, the glass substrate used to form the display systems maybe strengthened to exhibit a DOC that is described a fraction of the thickness t of the glass substrate (as described herein). For example, in one or more embodiments, the DOC may be equal to or greater than about 0.05t, equal to or greater than about 0.1t, equal to or greater than about 0.11t, equal to or greater than about 0.12t, equal to or greater than about 0.13t, equal to or greater than about 0.14t, equal to or greater than about 0.15t, equal to or greater than about 0.16t, equal to or greater than about 0.17t, equal to or greater than about 0.18t, equal to or greater than about 0.19t, equal to or greater than about 0.2t, equal to or greater than about 0.21t. In some embodiments, The DOC may be in a range from about 0.08t to about 0.25t, from about 0.09t to about 0.25t, from about 0.18t to about 0.25t, from about 0.11t to about 0.25t, from about 0.12t to about 0.25t, from about 0.13t to about 0.25t, from about 0.14t to about 0.25t, from about 0.15t to about 0.25t, from about 0.08t to about 0.24t, from about 0.08t to about 0.23t, from about 0.08t to about 0.22t, from about 0.08t to about 0.21t, from about 0.08t to about 0.2t, from about 0.08t to about 0.19t, from about 0.08t to about 0.18t, from about 0.08t to about 0.17t, from about 0.08t to about 0.16t, or from about 0.08t to about 0.15t. In some instances, the DOC may be about 20 μm or less. In one or more embodiments, the DOC may be about 40 μm or greater (e.g., from about 40 μm to about 300 μm, from about 50 μm to about 300 μm, from about 60 μm to about 300 μm, from about 70 μm to about 300 μm, from about 80 μm to about 300 μm, from about 90 μm to about 300 μm, from about 100 μm to about 300 μm, from about 110 μm to about 300 μm, from about 120 μm to about 300 μm, from about 140 μm to about 300 μm, from about 150 μm to about 300 μm, from about 40 μm to about 290 μm, from about 40 μm to about 280 μm, from about 40 μm to about 260 μm, from about 40 μm to about 250 μm, from about 40 μm to about 240 μm, from about 40 μm to about 230 μm, from about 40 μm to about 220 μm, from about 40 μm to about 210 μm, from about 40 μm to about 200 μm, from about 40 μm to about 180 μm, from about 40 μm to about 160 μm, from about 40 μm to about 150 μm, from about 40 μm to about 140 μm, from about 40 μm to about 130 μm, from about 40 μm to about 120 μm, from about 40 μm to about 110 μm, or from about 40 μm to about 100 μm.

In one or more embodiments, the glass substrate used to form the display systems may have a CS (which may be found at the surface or a depth within the glass article) of about 200 MPa or greater, 300 MPa or greater, 400 MPa or greater, about 500 MPa or greater, about 600 MPa or greater, about 700 MPa or greater, about 800 MPa or greater, about 900 MPa or greater, about 930 MPa or greater, about 1000 MPa or greater, or about 1050 MPa or greater.

In one or more embodiments, the glass substrate used to form the display system cover glass may have a maximum tensile stress or central tension (CT) of about 20 MPa or greater, about 30 MPa or greater, about 40 MPa or greater, about 45 MPa or greater, about 50 MPa or greater, about 60 MPa or greater, about 70 MPa or greater, about 75 MPa or greater, about 80 MPa or greater, or about 85 MPa or greater. In some embodiments, the maximum tensile stress or central tension (CT) may be in a range from about 40 MPa to about 100 MPa.

Aspect (1) pertains to a display system comprising: a display unit configured to display an image to a user; a sensor configured to detect an event comprising at least one of an interaction with the display system by the user, and an ambient lighting condition in an environment of the display system; and a control unit configured to determine a specified region of the display unit corresponding to a targeted area of the event, and configured to change a spatial luminance of the display system based on the event, wherein the display system is configured to switch from a first operation mode to a second operation mode when the event is detected, wherein, in the second operation mode, a luminance of the specified region relative to one or more other regions of the display unit is different than a luminance of the specified region relative to the one or more other regions in the first operation mode.

Aspect (2) pertains to the display system of Aspect (1), further comprising a light source configured to produce light to illuminate the image of the display unit, wherein, in the first operation mode, the light source is configured to produce a uniform spatial luminance, and, in the second operation mode, the light source is configured to produce a variable spatial luminance.

Aspect (3) pertains to the display system of Aspect (2), wherein the light source is at least one of a backlight unit, a laser projection system, and a plurality of light-emitting diodes.

Aspect (4) pertains to the display system of any one of Aspects (1) through (3), further comprising a substrate intermediate the display unit and the user, the substrate comprising a first surface arranged to face the user and a second surface opposite the first surface, and the substrate being at least partially transparent to the light produced by the light source.

Aspect (5) pertains to the display system of Aspect (4), wherein the substrate is at least partially transparent to light in a range from about 400 nm to about 700 nm.

Aspect (6) pertains to the display system of Aspect (5), wherein the substrate comprises an average light transmittance in a range of at least 90% along a wavelength range from about 400 nm to about 700 nm.

Aspect (7) pertains to the display system of any one of Aspects (4) through (6), wherein the substrate comprises a glass, glass-ceramic, or ceramic composition.

Aspect (8) pertains to the display system of Aspect (7), wherein the substrate comprises an alkali aluminosilicate glass or a boroaluminosilicate glass.

Aspect (9) pertains to the display system of Aspect (7) or Aspect (8), wherein the substrate comprises an average thickness between the first surface and the second surface in a range from about 0.05 mm to about 2 mm, from about 0.3 mm to about 1.5 mm, from about 0.5 mm to about 1.1 mm, or from about 0.7 mm to about 1 mm.

Aspect (10) pertains to the display system of any one of Aspects (4) through (9), wherein the substrate is formed from a strengthened glass material.

Aspect (11) pertains to the display system of Aspect (10), wherein the substrate is chemically strengthened.

Aspect (12) pertains to the display system of any one of Aspects (4) through (10), wherein the substrate is curved comprising a first radius of curvature.

Aspect (13) pertains to the display system of Aspect (12), wherein the first radius of curvature is in a range from about 20 mm to about 10,000 mm.

Aspect (14) pertains to the display system of Aspect (12) or Aspect (13), wherein the substrate comprises a second radius of curvature different from the first radius of curvature.

Aspect (15) pertains to the display system of any one of Aspects (4) through (14), wherein the substrate layer is cold-formed to the curved shape.

Aspect (16) pertains to the display system of any one of Aspects (1) through (15), wherein the display unit comprises at least one of an OLED display, LCD display, LED display or a DLP MEMS chip.

Aspect (17) pertains to the display system of any one of Aspects (1) through (16), wherein the sensor comprises at least one of a touch panel, a proximity sensor, a light sensor, an ultrasonic sensor, an optical image sensor, an eye-tracking system, and a microphone.

Aspect (18) pertains to the display system of Aspect (17), wherein the interaction by the user is at least one of: a touch by the user detected by at least one of the touch panel, the light sensor, the optical image sensor, and the ultrasonic sensor; a proximity of the user to the proximity sensor, the optical image sensor, or the ultrasonic sensor; a gesture by the user detected by at least one of the touch panel, the light sensor, the ultrasonic sensor, and the optical image sensor; a viewing direction of one or both eyes of the user detected by the eye tracking system; and a voice activation by the user detected by the microphone.

Aspect (19) pertains to the display system of Aspect (17), wherein the ambient lighting condition is at least one of: an amount of ambient light incident on the targeted area that exceeds a threshold amount; and a difference in brightness of ambient light incident on the targeted area relative to ambient light incident on the one or more other regions of the display unit.

Aspect (20) pertains to the display system of Aspect (17), wherein the touch panel is configured to detect a touch by the user on the first surface of the substrate.

Aspect (21) pertains to the display system of any one of Aspects (2) through (20), wherein the variable spatial luminance comprises one or more areas of a first luminance corresponding to the targeted area of the interaction, and one or more areas of a second luminance that do not correspond to the targeted area of the interaction, the first luminance being different than the second luminance.

Aspect (22) pertains to the display system of Aspect (21), wherein the first luminance is greater than or less than the second luminance.

Aspect (23) pertains to the display system of any one of Aspects (2) through (22), wherein the variable spatial luminance is configured to increase an ambient contrast ratio of the specified region of the display unit.

Aspect (24) pertains to the display system of any one of Aspects (1) through (23), wherein the specified region comprises less than 100% of a surface area of the display unit.

Aspect (25) pertains to the display system of any one of Aspects (2) through (24), wherein the variable spatial luminance comprises a variable luminance in one-dimension or in two-dimensions.

Aspect (26) pertains to the display system of any one of Aspects (17) through (25), wherein the touch panel is configured to detect a touch by the user in one-dimension or in two-dimensions.

Aspect (27) pertains to the display system of any one of Aspects (2) through (26), wherein the uniform spatial luminance comprises luminance values in a range from about 70% to 100% of a maximum luminance value of the backlight.

Aspect (28) pertains to the display system of any one of Aspects (2) through (27), wherein, when the display system is in an on state and in the first operation mode, the uniform spatial luminance comprises a luminance value L₀ for the light source and a luminance value L_{d0} for the display unit in a direction toward the user, and when the display system is in an off state, the display unit comprises a luminance value L_{d0off} in a direction toward the user.

Aspect (29) pertains to the display system of any one of Aspects (2) through (28), wherein the uniform spatial luminance of the light source comprises a maximum luminance Lₘₐₓ, and a range of luminance values in a range from about 70% to 100% of the maximum luminance Lₘₐₓ.

Aspect (30) pertains to the display system of Aspect (28) or Aspect (29), wherein an amount of ambient light directed to the user from the specified region is Lₐ, and an amount of ambient light directed to the user from the one or more other regions is Lₐ₀.

Aspect (31) pertains to the display system of Aspect (30), wherein Lₐ₀/Lₐ is less than 10.

Aspect (32) pertains to the display system of Aspect (30) or Aspect (31), wherein a contrast ratio CRₐ of the display system in the specified region in the first operation mode satisfies the following Equation 1:

$${CR}_{a} = \frac{{L}_{d 0} + {L}_{a}}{{L}_{d 0 off} + {L}_{a}} , \qquad Equation 1$$

and wherein a contrast ratio CRₐ₀ of the display system the one or more other regions satisfies the following Equation 2:

$$C {R}_{a 0} = \frac{{L}_{d 0} + {L}_{a 0}}{{L}_{d 0 off} + {L}_{a 0}} . \qquad Equation 2$$

Aspect (33) pertains to the display system of any one of Aspects (28) through Aspect (32), wherein, when the display unit in is in the on state and in the second operation mode, the specified region comprises a luminance value L₁ for the light source and a luminance value L_{d1} for the display unit in the on state and L_{d1off} in the off state, where L₁ is greater than L₀.

Aspect (34) pertains to the display system of Aspect (33), wherein, in the second operation mode, the one or more other regions comprise the luminance value L₀.

Aspect (35) pertains to the display system of Aspect (33) or Aspect (34), wherein a contrast ratio CRₐ of the display system in the specified region in the second operation mode satisfies the following Equation 3:

$$C {R}_{a } = \frac{{L}_{d 1} + {L}_{a }}{{L}_{d 1 off} + {L}_{a }} . \qquad Equation 3$$

Aspect (36) pertains to the display system of Aspect (18), wherein the touch panel is configured to detect a duration of the touch by the user, and the control unit is configured to adjust the luminance of the specified region by a variable degree based on the duration of the touch.

Aspect (37) pertains to the display system of any one of Aspects (1) through (36), wherein the light source comprises a first brightness level in a range from about 500 nits to about 1500 nits in the first operation mode.

Aspect (38) pertains to the display system of Aspect (37), wherein the light source comprises a second brightness level in a range from about 1000 nits to about 3000 nits at the specified region in the second operation mode, the second brightness level being greater than the first brightness level.

Aspect (39) pertains to the display system of any one of Aspects (1) through (38), wherein the display system is disposed on or in a vehicle dashboard, a vehicle center console, a vehicle door, a vehicle instrument cluster, a vehicle climate or radio control panel, an in-vehicle display, or a vehicle passenger entertainment panel.

Aspect (40) pertains to a vehicle comprising the display system of any one of Aspects (1) through (39).

Aspect (41) pertains to a method for providing local brightening for a display system comprising: providing a display module configured to display an image to a user of the display system; providing a light source configured to illuminate the image; providing a sensor configured to detect an event comprising at least one of an interaction with the display system by the user, and an ambient lighting condition in an environment of the display system; detecting the event; determining a specified region of the display unit corresponding to a targeted area of the event; and switching from a first operation mode of the display system to a second operation mode of the display system in response to the event, wherein the first operation mode comprises providing a uniform spatial luminance via the light source, the uniform spatial luminance comprising a first luminance value, and wherein the second operation mode comprises providing a variable spatial luminance comprising a second luminance value in the specified region and the first luminance value in one or more other regions of the display unit, the second luminance value being greater than the first luminance value.

Aspect (42) pertains to the method of Aspect (41), wherein the sensor comprises at least one of a touch panel, a proximity sensor, a light sensor, an ultrasonic sensor, an optical image sensor, an eye-tracking system, and a microphone.

Aspect (43) pertains to the method of Aspect (42), wherein the interaction by the user is at least one of: a touch by the user detected by at least one of the touch panel, the light sensor, the optical image sensor, and the ultrasonic sensor; a proximity of the user to the proximity sensor, the optical image sensor, or the ultrasonic sensor; a gesture by the user detected by at least one of the touch panel, the light sensor, the ultrasonic sensor, and the optical image sensor; a viewing direction of one or both eyes of the user detected by the eye tracking system; and a voice activation by the user detected by the microphone.

Aspect (44) pertains to the method of Aspect (42), wherein the ambient lighting condition is at least one of: an amount of ambient light incident on the targeted area that exceeds a threshold amount; and a difference in brightness of ambient light incident on the targeted area relative to ambient light incident on the one or more other regions of the display unit.

Aspect (45) pertains to the method of any one of Aspects (41) through (44), wherein the variable spatial luminance is configured to increase an ambient contrast ratio of the specified region of the display unit.

Aspect (46) pertains to the method of any one of Aspects (41) through (45), wherein the specified region comprises less than 100% of a surface area of the display unit.

Aspect (47) pertains to the method of any one of Aspects (41) through (46), wherein the light source is capable of a spatial luminance that is variable in one dimension or two dimensions.

Aspect (48) pertains to the method of Aspect (42) or Aspect (43), wherein the second luminance value is exhibited in an area corresponding to an area on the touch panel that detects the touch of the user.

Aspect (49) pertains to the method of any one of Aspects (41) through (48), wherein detecting the event comprising detecting a duration of the event and a magnitude of the second luminance value is based on the duration of the event.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A display system comprising:
a display unit configured to display an image to a user;
a sensor configured to detect an event comprising at least one of an interaction with the display system by the user, and an ambient lighting condition in an environment of the display system; and
a control unit configured to determine a specified region of the display unit corresponding to a targeted area of the event, and configured to change a spatial luminance of the display system based on the event,
wherein the display system is configured to switch from a first operation mode to a second operation mode when the event is detected,
wherein, in the second operation mode, a luminance of the specified region relative to one or more other regions of the display unit is different than a luminance of the specified region relative to the one or more other regions in the first operation mode.

2. The display system of claim 1, further comprising a light source configured to produce light to illuminate the image of the display unit,
wherein, in the first operation mode, the light source is configured to produce a uniform spatial luminance, and, in the second operation mode, the light source is configured to produce a variable spatial luminance.

3. (canceled)

4. The display system of claim 1, further comprising a substrate intermediate the display unit and the user, the substrate comprising a first surface arranged to face the user and a second surface opposite the first surface, and the substrate being at least partially transparent to the light produced by the light source.

5. (canceled)

6. (canceled)

7. The display system of claim 4, wherein the substrate comprises a glass, glass-ceramic, or ceramic composition.

8. (canceled)

9. (canceled)

10. (canceled)

11. (canceled)

12. The display system of claim 4, wherein the substrate is curved comprising a first radius of curvature.

13. (canceled)

14. The display system of claim 12, wherein the substrate comprises a second radius of curvature different from the first radius of curvature.

15. The display system of claim 4, wherein the substrate layer is cold-formed to the curved shape.

16. The display system of claim 1, wherein the display unit comprises at least one of an OLED display, LCD display, LED display or a DLP MEMS chip.

17. The display system of claim 1, wherein the sensor comprises at least one of a touch panel, a proximity sensor, a light sensor, an ultrasonic sensor, an optical image sensor, an eye-tracking system, and a microphone.

18. The display system of claim 17, wherein the interaction by the user is at least one of:
a touch by the user detected by at least one of the touch panel, the light sensor, the optical image sensor, and the ultrasonic sensor;
a proximity of the user to the proximity sensor, the optical image sensor, or the ultrasonic sensor;
a gesture by the user detected by at least one of the touch panel, the light sensor, the ultrasonic sensor, and the optical image sensor;
a viewing direction of one or both eyes of the user detected by the eye tracking system; and
a voice activation by the user detected by the microphone.

19. (canceled)

20. (canceled)

21. The display system of claim 2, wherein the variable spatial luminance comprises one or more areas of a first luminance corresponding to the targeted area of the interaction, and one or more areas of a second luminance that do not correspond to the targeted area of the interaction, the first luminance being different than the second luminance.

22. (canceled)

23. (canceled)

24. (canceled)

25. The display system of claim 2, wherein the variable spatial luminance comprises a variable luminance in one-dimension or in two-dimensions.

26. The display system of claim 17, wherein the touch panel is configured to detect a touch by the user in one-dimension or in two-dimensions.

27. (canceled)

28. The display system of claim 2, wherein, when the display system is in an on state and in the first operation mode, the uniform spatial luminance comprises a luminance value L₀ for the light source and a luminance value L_{d0} for the display unit in a direction toward the user, and
when the display system is in an off state, the display unit comprises a luminance value L_{d0off} in a direction toward the user.

29. (canceled)

30. (canceled)

31. (canceled)

32. (canceled)

33. (canceled)

34. (canceled)

35. (canceled)

36. The display system of claim 18, wherein the touch panel is configured to detect a duration of the touch by the user, and the control unit is configured to adjust the luminance of the specified region by a variable degree based on the duration of the touch.

37. (canceled)

38. (canceled)

39. The display system of claim 1, wherein the display system is disposed on or in a vehicle dashboard, a vehicle center console, a vehicle door, a vehicle instrument cluster, a vehicle climate or radio control panel, an in-vehicle display, or a vehicle passenger entertainment panel.

40. A vehicle comprising the display system of claim 1.

41. A method for providing local brightening for a display system comprising:
providing a display module configured to display an image to a user of the display system;
providing a light source configured to illuminate the image;
providing a sensor configured to detect an event comprising at least one of an interaction with the display system by the user, and an ambient lighting condition in an environment of the display system;
detecting the event;
determining a specified region of the display unit corresponding to a targeted area of the event; and
switching from a first operation mode of the display system to a second operation mode of the display system in response to the event,
wherein the first operation mode comprises providing a uniform spatial luminance via the light source, the uniform spatial luminance comprising a first luminance value, and
wherein the second operation mode comprises providing a variable spatial luminance comprising a second luminance value in the specified region and the first luminance value in one or more other regions of the display unit, the second luminance value being greater than the first luminance value.

42. The method of claim 41, wherein the sensor comprises at least one of a touch panel, a proximity sensor, a light sensor, an ultrasonic sensor, an optical image sensor, an eye-tracking system, and a microphone.

43. The method of claim 42, wherein the interaction by the user is at least one of:
a touch by the user detected by at least one of the touch panel, the light sensor, the optical image sensor, and the ultrasonic sensor;
a proximity of the user to the proximity sensor, the optical image sensor, or the ultrasonic sensor;
a gesture by the user detected by at least one of the touch panel, the light sensor, the ultrasonic sensor, and the optical image sensor;
a viewing direction of one or both eyes of the user detected by the eye tracking system; and
a voice activation by the user detected by the microphone.

44.-49. (canceled)
